(19) United States
(12) Patent Application Publication
(10) Pub. No.: US 2013/0054810 A1
(43) Pub. Date: Feb. 28, 2013

(54) MEDIA SERVICE DELIVERY APPARATUS AND METHOD USING SERVICE INTERWORKING IN CONVERGENCE MEDIA SERVICE DEVLIVERY SYSTEM

(71) Applicant: Nam-Kyung LEE, Daejeon (KR)

(72) Inventor: Nam-Kyung LEE, Daejeon (KR)

(73) Assignee: Electronics and Telecommunications Research Institute, Daejeon (KR)

(21) Appl. No.: 13/435,722

(22) Filed: Mar. 30, 2012

(30) Foreign Application Priority Data
Aug. 22, 2011 (KR) 10-2011-0083355
Mar. 22, 2012 (KR) 10-2012-0029538

(51) Int. Cl. G06F 15/173

(52) U.S. Cl. 709/226

(57) ABSTRACT

An apparatus and method for providing a media service by means of service interworking in a convergence media service delivery system are provided. The apparatus includes a service portal unit configured to search for a service in response to a request of a user accessing a service network; a service configuring unit configured to configure a convergence service that includes at least one service to be delivered to the user based on a result of searching for the service; and a service managing unit configured to allocate a service resource that is required for configuring the convergence service and to allocate or receive, if necessary, an optimal service resource to or from a different media service delivery apparatus based on a service level agreement.

### CROSS-REFERENCE TO RELATED APPLICATION(S)

This application claims the benefit under 35 U.S.C. §119(a) of Korean Patent Application Nos. 10-2011-0083355, filed on Aug. 22, 2011, and 10-2012-0029538, filed on Mar. 22, 2012, in the Korean Intellectual Property Office, the entire disclosures of which are incorporated herein by references for all purposes.

### BACKGROUND

1. Field

The following description relates to an apparatus and method for efficiently delivering broadcasting and communication services.

2. Description of the Related Art

A media service that combines the Internet, multimedia and communication services is delivered to users in real time. Such media services are provided to a user by a variety of service providers through media service delivery systems. The media service delivery systems are independent and exclusive from each other, and thus use of media services provided to the user by a number of service providers is restricted within a service area of a system to which the user is belonging. That is, the user is allowed to access only a service area of the system for the user.

### SUMMARY

The following description relates to an apparatus and method for efficiently delivering a media service by extending a range of delivery of services through service interworking in a convergence service delivery system.

In one general aspect, there is provided a media service delivery apparatus comprising: a service portal unit configured to search for a service in response to a request of a user accessing a service network; a service configuring unit configured to configure a convergence service that includes at least one service to be delivered to the user based on a result of searching for the service; and a service managing unit configured to allocate a service resource that is required for configuring the convergence service and to allocate or receive, if necessary, an optimal service resource to or from a different media service delivery apparatus based on a service level agreement.

In another general aspect, there is provided a media service delivery method of a media service delivery apparatus, comprising: receiving a message; in response to the received message being a service request from a user accessing a service network, allocating a service resource with respect to the service requested by the user; and in response to the received message being a service arbitration request, verifying a service level agreement and providing a service resource to a different media service delivery apparatus.

Other features and aspects may be apparent from the following detailed description, the drawings, and the claims.

### BRIEF DESCRIPTION OF THE DRAWINGS

FIG. 1 is a diagram illustrating an example of a media service delivery apparatus for supporting different service areas to interwork in a convergence media service delivery system.

FIG. 2 is a diagram illustrating in detail an example of a media service delivery apparatus shown in FIG. 1.

FIG. 3 is a flowchart illustrating an example of message transmission process being performed by a media service delivery apparatus for interworking between different service areas in a convergence service delivery system.

FIG. 4 is a flowchart illustrating an example of request processing process being performed by a media service delivery apparatus in response to a request of a user for a service or a request of another media service delivery apparatus for service arbitration.

FIG. 5 is a flowchart illustrating an example of processing process being performed by a second media service delivery apparatus in response to a request of a first media service delivery apparatus for service arbitration.

FIG. 6 is a diagram illustrating an example of a convergence service delivery system in which two different service areas are interworking each other.

Throughout the drawings and the detailed description, unless otherwise described, the is same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

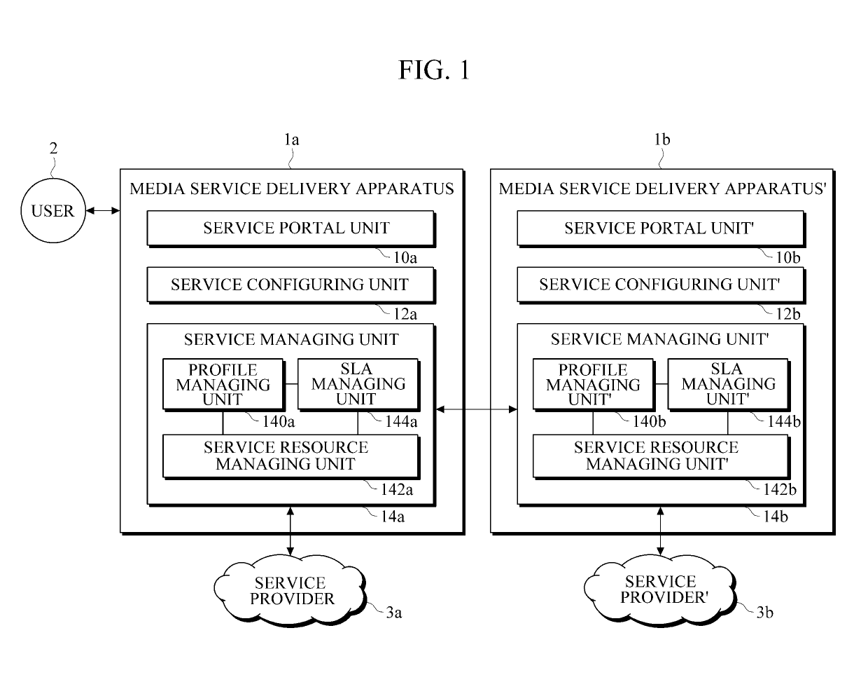

FIG. 1 is a diagram illustrating an example of a media service delivery apparatus for supporting different service areas to interwork in a convergence media service delivery system.

Referring to FIG. 1, a convergence media service delivery system includes one or more media service delivery apparatuses 1a and 1b, one or more service providers 3a and 3b, and one or more users 2. A first media service delivery apparatus 1a may include a service portal unit 10a, a service configuring unit 12a and a service managing unit 14a.

The first media service delivery apparatus 1a is in the form of a media service platform (MSP) to deliver and control a service provided from a first service provider 3a. Particularly, the first media service delivery apparatus 1a may be in the form of an open application programming interface (API) service platform.

The first service provider 3a may be an application service provider (ASP) that provides application services. Alternatively, the first service provider 3a may be a content provider (CP) that offers content. The first media service delivery apparatus 1a may provide an interface to control and deliver an application and a service to the user 2 from ASP or CP over an Internet protocol (IP) delivery network.

Access to a service network by the user 2 is subject to user authentication, and once the user authentication is completed, the user 2 is allowed to access the service portal unit 10a of the media service delivery apparatus 1a, and searches for a desired service from the service portal unit 10a. The service portal unit 10a may control the user authentication and the service access, and support the user 2 to browse and search for services. The service provider 3a provides a service to the user 2 via the media service delivery apparatus 1a. The service is a convergence service of Internet, multimedia and communication, and it may be, for example, an IPTV service or a smart TV service. A smart TV is a multifunctional and intelligence next-generation multimedia device that integrates TV and Internet functions.

The service configuring unit 12a may configure a convergence service that includes at least one service to be delivered to the user 2 from the first service provider 3a. The convergence service may be formed by converging, for example, the Internet, multimedia and communication services.

The service managing unit 14a performs a series of functions to deliver a service between service areas, for example, transmission and reception of messages, check of user information, check of service provider information, reservation of available service resources, and storage of service provision information.

In one example, the service managing unit 14a allocates service resources that are required by the service configuring unit 12a to configure the convergence service. In addition, the service managing unit 14a may communicate with a second media service delivery apparatus 1b to optimally allocate the service resources in conformity with service level agreement (SLA). The service level agreement (SLA) is a contract between the service provider 3a and the user 2 to ensure the quality of service at a constant level, thereby improving user satisfaction in using the service.

In one example, the service managing unit 14a may include a profile managing unit 140a, a service resource managing unit 142a, and a service level agreement managing unit 144a.

The service resource managing unit 142a manages service resources, and, in response to a request of the user for a service, allocates the service resources with respect to the service provided by the service provider 3a.

The profile managing unit 140a manages a user profile and a service profile which are required when the service resource managing unit 142a allocates service resources. The user profile is used for verifying whether a user is authorized to use a service and the service profile is used for verifying whether a user is authorized to access the service.

The service level agreement managing unit 144a verifies the service level agreement, and performs service arbitration in an effort to provide service resources to the second media service delivery apparatus 1b or to request and receive service resources from the second media service delivery apparatus 1b. In one example, if a service requested by the user 2 is not present in a service list, the service level agreement managing unit 144a may request the second media service delivery apparatus 1b for service arbitration and thereby the second media service delivery apparatus 1b may arbitrate the provision of service resources to the first media service delivery apparatus 1a. In another example, in response to a request of the second media service delivery apparatus 1b for service arbitration, the service level agreement managing unit 144a may verify the service level agreement, and then arbitrate the provision of service resources to the second media service delivery apparatus 1b.

In this example, the service level agreement managing unit 144a performs service arbitration in conformity with the service level agreement, such that the service resources suitable to ensure the quality of service (QoS) of the service requested by the user 2 can be received from or provided to the second media service delivery apparatus 1b.

In addition, the service level agreement managing unit 144a restricts the user 2 to the service resources that are suitable to ensure the QoS of the service requested by the user 2. This is to provide the user with a certain level of service.

In one example, in response to a request of the user 2 for a different service, the service level agreement managing unit 144a collects and analyzes service resources with respect to the different service request, and provides an optimal service resource to the user 2.

The service managing unit 14a may make it possible to extend available service resources for the user 2 from one service area that is connected to one service network to the entire service areas including other service areas connected to different service networks, and thereby it may be possible to extend a range of delivery and provision of available services. Accordingly, the user 2 is allowed to use a different service that is provided by another service provider 3b even when the user 2 is a subscriber of the service provided by the service provider 3a.

The second media service delivery apparatus 1b has the same configuration as the first media service delivery apparatus 1a, and thus includes a service portal unit 10b, a service configuring unit 12bm and a service managing unit 14b. The service managing unit 14b includes a profile managing unit 140b, a service resource managing unit 142b, and a service level agreement managing unit 144b like the service managing unit 14a of the first media service delivery apparatus 1a.

Although in the example shown in FIG. 1, two media service delivery apparatuses 1a and 1b are provided for convenience of explanation, there may be present more than two media service delivery apparatuses, and there may be present two or more users and service providers. In the presence of a plurality of users and service providers, service resources are provided from different service networks in accordance with the service level agreement, and the provided service resources are analyzed to offer an optimal service resource to the user 2.

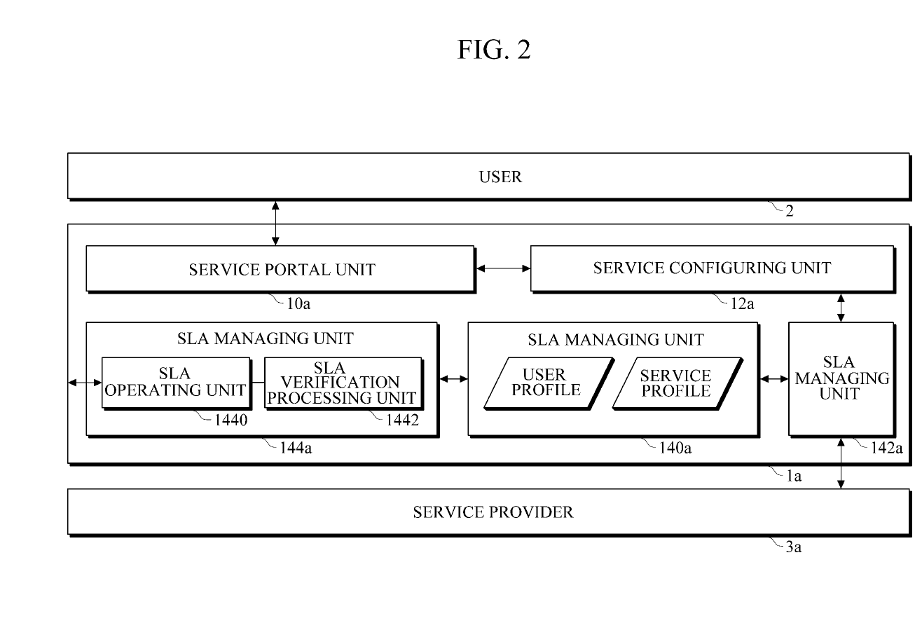

FIG. 2 is a diagram illustrating in detail an example of a media service delivery apparatus shown in FIG. 1.

Operations of elements included in a media service delivery apparatus 1a will be described with reference to FIG. 2.

A user 2 accesses a service network and user authentication is performed. Once the user authentication is completed, the user 2 is allowed to access a service portal unit 10a of the media service delivery apparatus 1a to search for a specific service. Service information that includes a user's search result is delivered to a service configuring unit 12a. In response to the service information being received, the service configuring unit 12a searches for a service resource to configure a service.

Then, the service configuring unit 12a looks up a user profile in a profile managing unit 140a to verify whether the user 2 is authorized to use a service, and looks up a service profile in a profile managing unit 140a to verify whether the user is authorized to access the service. If the two verification requirements are satisfied, a service resource managing unit 142a checks whether a service requested by the user 2 is present in a service list. If the requested service is present in the service list, a corresponding service resource is allocated. On the contrary, if the requested service is not present in the service list, the service resource managing unit 142a requests a service level agreement operating unit 1440 of a service level agreement managing unit 144a for service arbitration. In response to the request from the service resource managing unit 142a, the service level agreement operating unit 1440 requests a service level agreement managing unit of another media service delivery apparatus, and if the media service delivery apparatus allocates a service resource, the service level agreement operating unit 1440 receives a service arbitration response from the media service delivery apparatus. A service level agreement verification processing unit 1442 verifies a service level agreement for service arbitration in response to a request of the different media service delivery apparatus for service arbitration.

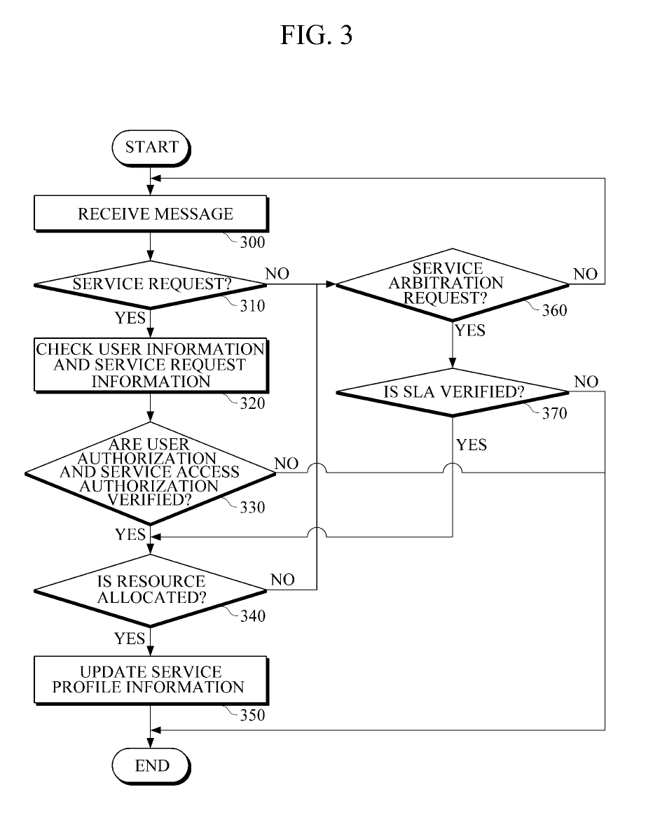

FIG. 3 is a flowchart illustrating an example of message transmission process being performed by a media service delivery apparatus for interworking between different service areas in a convergence service delivery system.

Referring to FIGS. 1 and 3, the media service delivery apparatus 1a receives a message in operation 300. If it is determined in operation 310 that the message received from the user 2 accessing a service network is a service request, user information and service request information are checked in operation 320. Then, in response to the user information and the service request information being checked, user authorization for use of a service and service access authorization are verified in operation 330, and a service resource with respect to the service requested by the user 2 is allocated in operation 340. Then, service profile information is updated in operation 350 and a service response message is transmitted to the user 2.

On the contrary, if it is determined in operation 360 that the message received from the user 2 is a service arbitration request, the service level agreement is verified in operation 370 and then an available service resource is allocated in operation 340 and a service response message is transmitted to another media service delivery apparatus 1b that has requested the service arbitration.

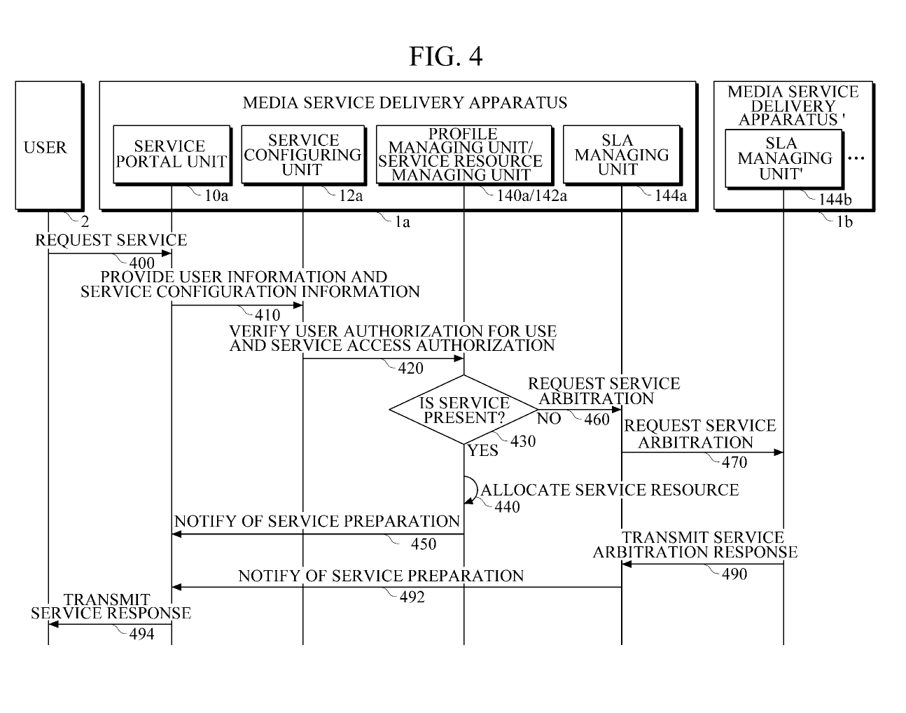

FIG. 4 is a flowchart illustrating an example of request processing process being performed by a media service delivery apparatus in response to a request of a user for a service or a request of another media service delivery apparatus for service arbitration.

Referring to FIGS. 1 and 4, the service portal unit 10a of the first media service delivery apparatus 1a receives a service request message from the user 2 in operation 400. In response to the service request message, the service portal unit 10a transmits user information and service configuration information to the service configuring unit 12a in operation 410. The service configuring unit 12a requests the service resource managing unit 142a to verify user authorization for use of a service and service access authorization in operation 420. In response to the request from the service configuring unit 12a, the service resource managing unit 142a verifies the user authorization for use of a service and the service access authorization by using the service profile and the service profile which are included in the profile managing unit 140a.

In response to the user authorization and service access authorization being verified, the service resource managing unit 142a checks whether the service requested by the user 2 is present in a service list in operation 430. If the requested service is present in the service list, the service resource managing unit 142a allocates a service resource with respect to the requested service in operation 440. Then, the service resource managing unit 142a notifies the service portal unit 10a of the provision of the service in operation 450. In response to the notification being received, the service portal unit 10a delivers the user 2 with the corresponding service in operation 494.

If it is determined in operation 430 that the service requested by the user is not present in the service list, the service resource managing unit 142a requests the service level agreement managing unit 144a for service arbitration in operation 460. In response to the request for the service arbitration, the service level agreement managing unit 144a requests the second media service delivery apparatus 1b for service arbitration in operation 470. In response to the request for service arbitration, the second media service delivery apparatus 1b allocates a service resource corresponding to the service requested by the user 2 and transmits a service arbitration response to the service level agreement managing unit 144a in operation 490. Then, the service resource managing unit 142a notifies the service portal unit 10a of the provision of the service in operation 450, and the service portal unit 10a delivers the user 2 with the corresponding service in operation 494.

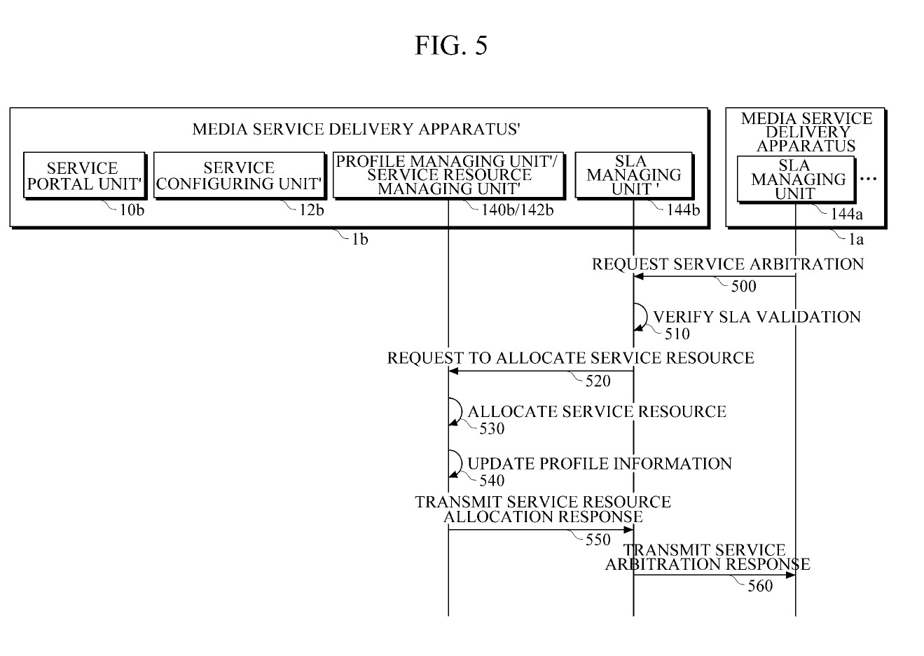

FIG. 5 is a flowchart illustrating an example of processing process being performed by a second media service delivery apparatus in response to a request of a first media service delivery apparatus for service arbitration.

The service level agreement managing unit 144b of the second media service delivery apparatus 1b receives a service arbitration request message from the service level agreement managing unit 144a of the first media service delivery apparatus 1a in operation 500. Then, in response to the service arbitration request message, the service level agreement managing unit 144b verifies a service level agreement in operation 510. In response to the verification of the service level agreement being completed, the service level agreement managing unit 144b requests the service resource managing unit 142b to allocate a service resource in operation 520, and in response to this request, the service resource managing unit 142b allocates a service resource in operation 530. Then, the profile managing unit 140b updates profile information in operation 540. Thereafter, the service resource managing unit 142b transmits a service resource allocation response message to the service level agreement managing unit 144b in operation 550, and the service level agreement managing unit 144b transmits a service arbitration response message to the service level agreement managing unit 144a of the first media service delivery apparatus 1a in operation 560.

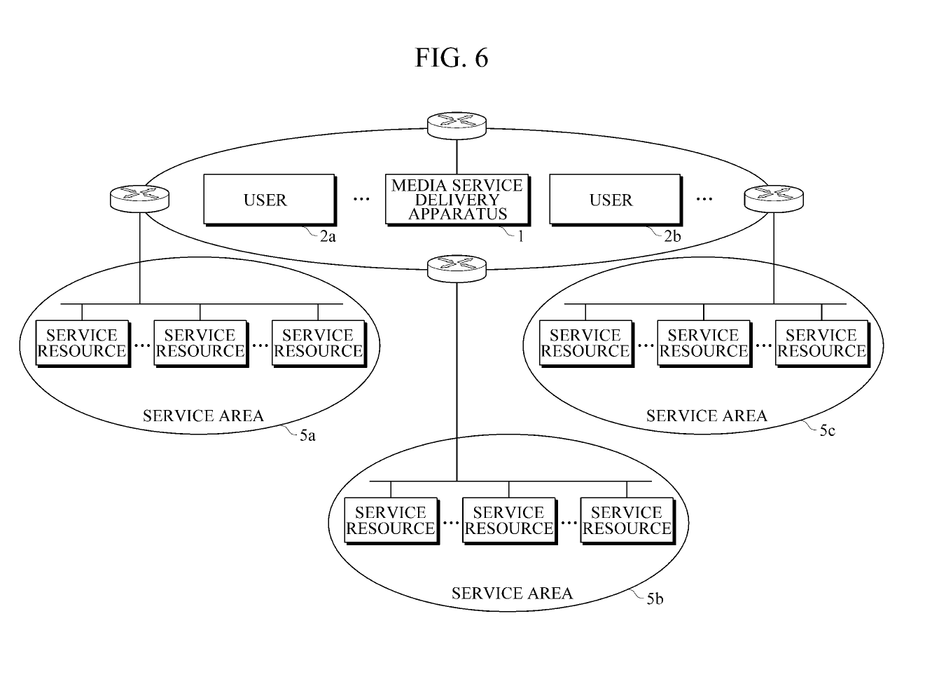

FIG. 6 is a diagram illustrating an example of a convergence service delivery system in which two different service areas are interworking each other.

Referring to FIG. 6, a media service delivery apparatus 1 allows two users 2a and 2b to be connected to different service areas 5a, 5b, and 5c. In this example, the users 2a and 2b are allowed to access service resources in each of the different independent service areas 5a, 5b, and 5c.

According to the embodiments described above, a user can be provided with available service resources not only from one service area that is connected to one service network, but also from the entire service areas which are connected to different service networks, and thus it is possible to extend a range of delivery and provision of available services. Accordingly, the user as a subscriber of one service provided from a given service provider is allowed to use a different service provided from another service provider. In addition, it is possible to provide an open application programming interface service platform that controls and delivers a service to a user.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A media service delivery apparatus comprising:
a service portal unit configured to search for a service in response to a request of a user accessing a service network;
a service configuring unit configured to configure a convergence service that includes at least one service to be delivered to the user based on a result of searching for the service; and
a service managing unit configured to allocate a service resource that is required for configuring the convergence service and to allocate or receive, if necessary, an optimal service resource to or from a different media service delivery apparatus based on a service level agreement.

2. The media service delivery apparatus of claim 1, wherein the service managing unit is configured to comprise
is a service resource managing unit configured to manage service resources and to allocate a service resource with respect to a service that is provided from a service provider in response to a service request from the user,
a profile managing unit configured to manage a user profile for verifying user authorization for use of service and a service profile for verifying service access authorization wherein the user profile and the service profile are used for the service resource managing unit to allocate the service resource, and
a service level agreement managing unit configured to verify a service level agreement and to arbitrate a service so as to provide a service resource to the different media service delivery apparatus or to issue a request for a service resource and receive the service resource from the different media service delivery apparatus.

3. The media service delivery apparatus of claim 2, wherein the service level agreement managing unit is configured to, if the service requested by the user is not present in a service list, request the different media service delivery apparatus for service arbitration and thereby cause the different media service delivery apparatus to perform arbitration for providing a service resource to the media service delivery apparatus.

4. The media service delivery apparatus of claim 2, wherein the service level agreement managing unit is configured to, in response to a request of the different media service delivery apparatus for service arbitration, verify the service level agreement and then perform arbitration for providing a service resource to the different media service delivery apparatus.

5. The media service delivery apparatus of claim 2, wherein the service level agreement managing unit is configured to receive or provide a service resource that is suitable to ensure a quality of service (QoS) of the service requested by the user from or to the different media service delivery apparatus in conformity of the service level agreement.

6. The media service delivery apparatus of claim 2, wherein the service level agreement managing unit is configured to restrict the user to a service resource that is suitable to ensure a QoS of the service requested by the user.

7. The media service delivery apparatus of claim 2, wherein the service level agreement managing unit is configured to receive service resources from different service networks in conformity of the service level agreement, and to analyze the received service resources to offer an optimal service resource to the user.

8. The media service delivery apparatus of claim 2, wherein the service level agreement managing unit is configured to, in response to a request of the user for a different service, collect and analyze service resources with respect to the different service, and to provide an optimal service resource to the user.

9. The media service delivery apparatus of claim 1, wherein the convergence service provided is a smart TV service.

10. The media service delivery apparatus of claim 1, wherein the convergence service provided is an Internet protocol (IP) TV service.

11. A media service delivery method of a media service delivery apparatus, comprising:
receiving a message;
in response to the received message being a service request from a user accessing a service network, allocating a service resource with respect to the service requested by the user; and
in response to the received message being a service arbitration request, verifying a service level agreement and providing a service resource to a different media service delivery apparatus.

12. The media service delivery method of claim 11, wherein the allocating of the service resource with respect to the service requested by the user comprises
checking user information and service request information prior to the allocation of the service resource and
in response to the user information and service request information being checked, verifying user authorization for use of service and service access authorization.

13. The media service delivery method of claim 11, wherein the allocating of the service resource with respect to the service requested by the user comprises
checking the presence of the service requested by the user, and
if the requested service is present, allocating a service resource with respect to the requested service, and otherwise, requesting the different media service delivery apparatus to provide a service resource.
